(19) United States
(12) Patent Application Publication
(10) Pub. No.: US 2020/0105020 A1
(43) Pub. Date: Apr. 2, 2020

(54) METHOD OF SPECTRAL ANALYZING WITH A COLOR CAMERA

(71) Applicant: CHENG MEI INSTRUMENT TECHNOLOGY CO., LTD., Zhubei City (TW)

(72) Inventors: Chi-Yuan LIN, Zhubei City (TW); Cheng-En CHIANG, Zhubei City (TW); Hung Chun LO, Zhubei City (TW); Chun Pin HSU, Zhubei City (TW); Chi Lu HUANG, Zhubei City (TW); Chao-Yu HUANG, Zhubei City (TW); Cheng-Tao TSAI, Zhubei City (TW)

(21) Appl. No.: 16/590,198

(22) Filed: Oct. 1, 2019

Related U.S. Application Data
(60) Provisional application No. 62/739,452, filed on Oct. 1, 2018.

(51) Int. Cl. G06T 7/90; G06T 7/00; H04N 17/00; H04N 17/02; G01J 3/28; G01J 3/02

(52) U.S. Cl. CPC G06T 7/90; G06T 7/001; H04N 17/002; H04N 17/02; G01J 2003/2826; G01J 3/0297; G06T 2207/10024; G06T 2207/30108; G01J 3/2823

(57) ABSTRACT

A method of spectral analyzing with a color camera is provided, and the method includes: calibrating a color camera to obtain a quantum efficiency database of the color camera; shooting a detection area with the color camera, the detection area including at least one object, to obtain the color content data of the at least one object; and comparing the color content data to the quantum efficiency database to analyze the at least one object.

### CLAIM FOR PRIORITY

This application claims priority to U.S. Provisional Patent Application No. 62/739,452 filed on Oct. 1, 2018.

### BACKGROUND OF THE INVENTION

### Field of the Invention

The present invention relates to a method of spectral analyzing, and more particularly, relates to a method of spectral analyzing with a color camera.

### Descriptions of the Related Art

In the detection process of the manufacturing industry, for example, for products such as LEDs, dyes or the like that emit fluorescent light and may have substances emitting fluorescent light remained therein, a spectrometer is usually adopted for product testing and analyzing to further complete quality screening.

A traditional spectrometer operates in a point-scanning or line-scanning mode in order to obtain information of a detection area. Because the range of the detection area captured by a single triggering and shooting through the point-scanning or line-scanning is considerably small (only covering a partial spot-shaped or line-shaped area of the product), many times of triggering and shooting are required in combination with an X and Y-axis platform for scanning the product(s) in order to obtain all information of the products. This consumes a lot of time (i.e., information of multiple detection areas is required in order to obtain complete detection data), and meanwhile, a huge amount of data is accordingly generated. In this way, not only the time required for many software operations is increased, but also the complexity of analysis is increased.

In other words, in a single triggering and shooting of the point-scanning or line-scanning, the amount of information actually available for detection/analysis is very small, and the information captured each time in image shooting triggered by the point-by-point or line-by-line scanning is discontinuous and segmented, which severely affects the result of subsequent analyses.

Accordingly, a need exists in the art to improve the aforesaid drawbacks.

### SUMMARY OF THE INVENTION

An objective of the present invention is to provide a method of spectral analyzing, and more particularly, relates to a method of spectral analyzing with a color camera.

To achieve the aforesaid objective, a method of spectral analyzing provided by the present invention comprises: calibrating a color camera to obtain a quantum efficiency (which is called QE for short) database of the color camera; shooting a detection area comprising at least one object with the color camera to obtain the color content data of the at least one object; and comparing the color content data to the quantum efficiency database to analyze the at least one object. The detection area covers at least one object for analysis.

In an embodiment, the step of calibrating a color camera comprises: illuminating an image sensor of the color camera with a light beam, wherein the light beam is a narrow bandwidth light beam which may be a tunable laser beam, or the light beam may be provided by a general light source used in combination with a monochromator or filter. Thus, a quantum efficiency database, which can be further plotted as a quantum efficiency curve graph, is obtained by changing the wavelength of the incident light beam.

In an embodiment, the step of shooting a detection area with the color camera comprises: providing an imaging lens set on the color camera to shoot the detection area.

In an embodiment, the method of spectral analyzing further comprises: shooting a qualified product with the color camera to obtain standard color content data, and the standard color content data may comprise RGB color content proportions, lighting intensity values or the like.

In an embodiment, the method of spectral analyzing further comprises: comparing the standard color content data with the quantum efficiency database to set a qualified range, i.e., the method may comprise setting a qualified range of center wavelengths and a qualified range of lighting intensities according to detection demands.

In an embodiment, the method of spectral analyzing further comprises: comparing the color content data of the at least one object obtained from the color camera with the quantum efficiency database to know whether the at least one object is qualified.

In an embodiment, the method of spectral analyzing further comprises: comparing the color content data of the at least one object obtained from the color camera with the standard color content data to know whether the at least one object is qualified.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is schematic flowchart diagram of a method according to the present invention;

FIG. 2A is a schematic view of a quantum efficiency database obtained by the method according to the present invention;

FIG. 2B is a schematic view illustrating RGB gray-level values obtained after shooting a qualified product and an object under test according to the method of the present invention;

FIG. 3 is a schematic flowchart diagram of generating an image by a Bayer camera; and

FIG. 4 and FIG. 5 are respectively a schematic spectral response diagram and a schematic QE diagram of a camera provided by a camera manufacturer for description and sale of the product.

### DESCRIPTION OF THE PREFERRED EMBODIMENT

The method of spectral analyzing with a color camera provided by the present invention may be used for purposes of detecting the quality of a product and analyzing substance composition thereof or the like. Before the detection, different excitation light sources of different wavelengths are preferably irradiated in combination with different objects so that the color camera obtains sufficient fluorescent information during the shooting, thereby detecting products such as different types and different sizes of LEDs and dyes that emit fluorescent light or may have substances emitting fluorescent light remained therein. The stronger the focusing intensity of the light source irradiated onto the object is, the stronger the fluorescent information that may be obtained by shooting the object will be; and the exposure time when shooting the object may be reduced to increase the detection speed, but the present invention is not limited thereto. When the fluorescent information emitted from the object itself is sufficient, it is unnecessary to first irradiate the object with the excitation light source.

In an embodiment, the color camera may be further connected with an external device, and the external device may comprise components such as an automated machine and an electronic equipment (not shown) to manipulate the color camera to shoot and record and compare data. Since the external device is not the key point of this embodiment and does not affect the subsequent description of the technical content, the description and depiction thereof will be omitted. Individual steps of the method of spectral analyzing with a color camera will be described hereinafter.

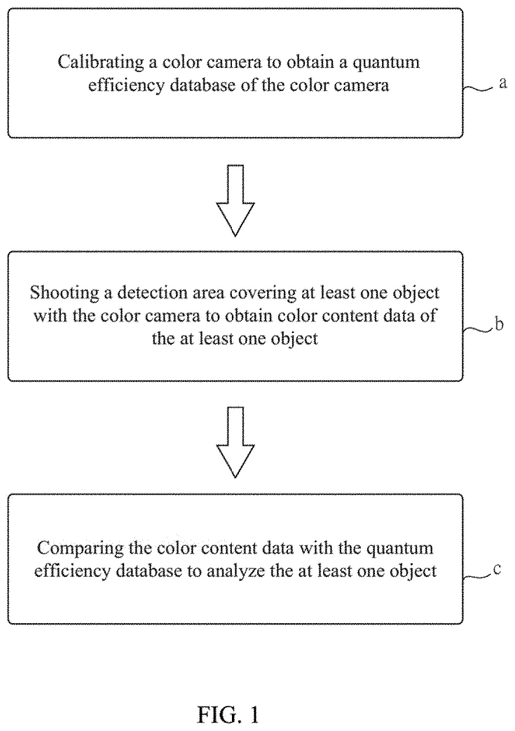

Referring to FIG. 1, the method of spectral analyzing with a color camera provided by the present invention comprises the following main steps: (a) calibrating a color camera to obtain a quantum efficiency (which is called QE for short) database of the color camera; (b) shooting a detection area with the color camera to obtain the color content data of the detection area; and (c) comparing the color content data with the quantum efficiency database.

In detail, the aforesaid step (a) of calibrating a color camera may further comprise: illuminating an image capturing module of the color camera for many times with a narrow bandwidth light beam (which may also be called a monochromatic light beam or a single-wavelength light beam) to obtain quantum efficiency values (which is called QE values for short) of various colors at different wavelengths of the color camera. The aforesaid narrow bandwidth light beam is a light beam of uniform intensity and it may be a tunable laser beam, or the narrow bandwidth light beam may be provided by a general light source used in combination with a monochromator or filter. The aforesaid step (b) of shooting a detection area with the color camera to obtain the color content data of the detection area may further comprise: providing an imaging lens set (e.g., a microscope lens assembly including elements such as an objective lens and a lens barrel) on the color camera to shoot the detection area. That is, the detection area comprises at least one object, and lenses of different amplification factors and different focal lengths may be selected depending on the category of the object so that at least one or more objects are included in each time of triggering and shooting, thereby improving the detection efficiency. The aforesaid step (c) of comparing the color content data with the quantum efficiency database may comprise: using an electronic equipment to compare the color content data of the object with the quantum efficiency database to know the spectral information of the object, which includes the center wavelength, the lighting intensity, the peak wavelength, the full width at half maximum or the like.

The aforesaid image capturing module comprises elements such as an image sensor, an analog-to-digital converter and an image processor or the like, and the image sensor (e.g., a charge coupled device (CCD) or a complementary metal oxide semiconductor (CMOS)) may be used to receive and convert the photon into an analog signal, the analog-to-digital converter may be used to convert the analog signal into a digital signal, and the image processor may process the digital signal, e.g., process the color, reduce the noise, detect the edge thereof or the like. The QE values of the method according to the present invention not only refer to the percentage of converting the photon received on the light-receiving surface of the image sensor into electron, but also comprise the responsivity of the image capturing module of the color camera after receiving the photon and the state presented on the image after the conversion, i.e., comprise gray-level values presented on the image after the photon is converted by various elements in the image capturing module.

To make the method of the present invention easier to be understood, the flow process of the step (a) of the present invention will be described in the following embodiments by taking the color camera in which the color filter array of the image sensor is in a Bayer arrangement pattern as an example.

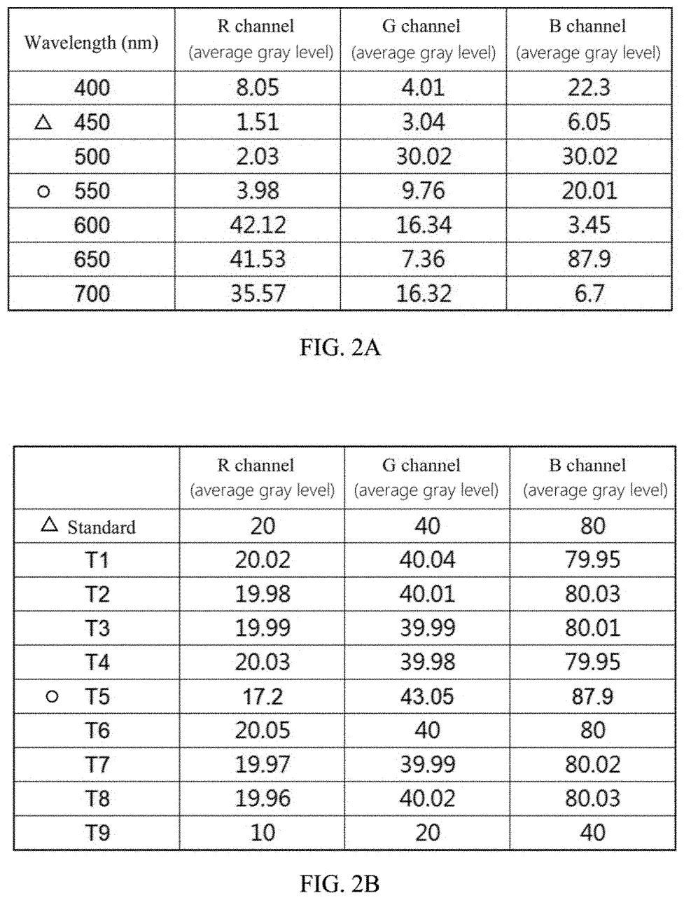

As shown in FIG. 2, a step of calibrating a Bayer color camera (which is called a camera for short hereinafter) may comprise: (S1) irradiating a broadband light source into an achromatic lens to focus the light source at an entrance slit of a monochromator; (S2) adjusting the width of an exit slit of the monochromator so that a narrowband light beam of which the bandwidth is 0.01 nm (W value) is formed when the light of the light source exits from the monochromator; (S3) using an electronic equipment to control the center wavelength of the narrowband light beam exiting from the monochromator to be 400 nm (L value); (S4) controlling the diameter of a light spot of the narrowband light beam exiting from the monochromator to be 1 cm (D value); (S5) measuring the power of the narrowband light beam by using an optical power meter, and adjusting the broadband light source provided in the step (S1) so that the power of the narrowband light beam is 40 mw (X value); (S6) fixing the exposure time of the camera to be 100 μs (Y value); (S7) setting the gain of the R, G and B lights of the camera to be 1× (one time, Z value); (S8) deactivating the image processing function (especially the color processing function) of the camera; (S9) illuminating the narrowband light beam exiting from the monochromator onto the image sensor of the camera, and outputting raw data from the camera to obtain RGB gray-level values. Thereafter, only the L value is changed (e.g., adjusted gradually from 400 nm to 700 nm), and the aforesaid steps (S2) to (S9) are repeated each time the L value is changed. In this way, the RGB gray-level values of various wavelengths that are presented on the image within a wavelength range can be obtained and tabulated into a gray-level and wavelength table (as shown in FIG. 2A). By the aforesaid calibrating operation, the user can use the camera to shoot an object so as to obtain RGB gray-level values in the image, thereby further knowing the spectral information and lighting intensity of the object.

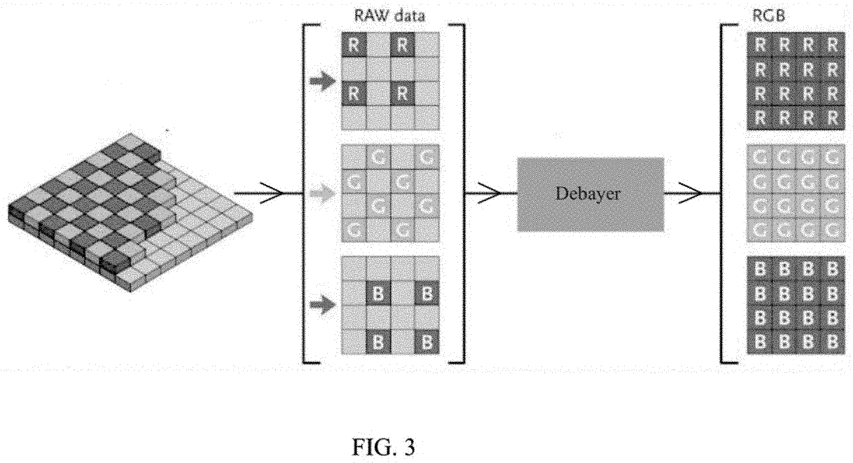

It shall be appreciated that, the aforesaid W, D, X, Y, and Z values are set for ease of understanding and are not equivalent to values in practical application, and the aforesaid color processing in the Bayer camera may comprise a debayer procedure, and may also comprise brightness and contrast adjustment or the like. The range in which the aforesaid L value is adjusted may be changed depending on practical detection demands and is preferably within an operable range of the camera. The aforesaid steps (S2) to (S8) are not limited to a particular execution order, and the specific steps executed and the setting of the values may be varied depending on the detection purpose and the operation habit of the user, or other values (e.g., dynamic ranges of the camera or the like) are further set. That is, operational steps of hardware details are changed depending on different types and models of cameras without departing from the scope claimed by the present invention. Besides, reference is made to FIG. 3, which is a schematic flowchart diagram of generating an image by a Bayer camera. In the step (S9), the RGB gray-level values can also be obtained by using the image after the debayer operation (i.e., through the interpolation operation) in addition to using the raw data, except that errors that might be caused by the debayer operation need to be taken into consideration.

The method of spectral analyzing with a color camera provided by the present invention may further comprise: shooting a qualified product with the color camera to obtain standard color content data; comparing the standard color content data with the quantum efficiency database to set a qualified range; and comparing the color content data of an object obtained from the color camera with the quantum efficiency database or the standard color content data to know whether the object falls within the qualified range.

That is, the method of the present invention may further divide products that may emit fluorescent light into different categories in terms of quality thereof. The standard color content data may comprise the color content proportion (e.g., a gold RGB ratio) and the lighting intensity value (e.g., a gold RGB intensity) (both of which are collectively referred to as “standard color content data” hereinafter). By comparing the color content proportion in the standard color content data to the quantum efficiency database, the center wavelength of the qualified product can be known, and an allowable wavelength range is set depending on the detection demands. By comparing the color content proportion in the color content data of the object to the quantum efficiency database, it can be known whether the center wavelength of the object falls within the qualified wavelength range. By comparing the lighting intensity value of the object to the lighting intensity value in the standard color content data, it can be known whether the lighting intensity of the object satisfies the standard.

The following description also takes the color camera in which the image sensor is in a Bayer arrangement pattern as an example. In detail, referring to FIG. 2A to FIG. 2B, if a blue optoelectronic semiconductor chip is to be detected, then first a camera that has been calibrated (of which the quantum efficiency database has been obtained) is used to shoot a qualified blue optoelectronic semiconductor chip, thereby obtaining the standard color content data of the qualified product. For example, in this embodiment, the RGB gray-level values are respectively 20:40:80, and it can be known that the center wavelength of the qualified product is 450 nm by comparing the proportions among the RGB values with the gray-level and wavelength table obtained after the calibration of the color camera (as shown in FIG. 2A). An allowable qualified wavelength range is set depending on the detection demands, e.g., the product of which the center wavelength ranges from 450 nm to 500 nm is set to be the qualified product, and an allowable qualified lighting intensity range which for example deviates from the reference value within ±5% is set. Next, objects T1 to T9 are detected to obtain color content data of the objects T1 to T9 (as shown in FIG. 2B), wherein the center wavelengths of the objects T1 to T4 and T6 to T9 are all about 450 nm when comparing the proportions of the RGB gray-level values with the gray-level and wavelength table, so the objects T1 to T4 and T6 to T9 are products of which the wavelengths are qualified. In contrast, the center wavelength of the object T5 is about 550 nm when comparing the proportion of the RGB gray-level values with the gray-level and wavelength table, and this means that the object T5 is a product of which the wavelength is abnormal.

Continuing with the aforesaid embodiment, the center wavelength of the object T9 conforms to the standard when comparing the proportion of 10:20:40 of the RGB gray-level values of the object T9 to the gray-level and wavelength table; however, the numerical values of the RGB gray-level values of the object T9 are all a half of the RGB gray-level values 20:40:80 of the qualified product and deviate from the RGB gray-level values 20:40:80 more than −5%, and this means that the lighting intensity of the object T9 is unqualified and the lighting intensity is insufficient. That is, the center wavelength of the object can be known from the proportion of the measured RGB gray-level values, and the lighting intensity of the object can be known from the numerical values of the RGB gray-level values. By the aforesaid steps, products can be classified into first-grade products (optimal qualified products), second-grade products (e.g., products of which the wavelength is qualified but the brightness is slightly insufficient or products of which the brightness is sufficient but the wavelength is slightly unqualified) and third-grade products (e.g., products of which the brightness and the wavelength are all unqualified) or the like according to the variation of the RGB gray-level values and depending on the detection demands.

As shall be appreciated by those of ordinary skill in the art, other available spectral information (e.g., the peak wavelength and the full width at half maximum) in addition to the data such as the center wavelength and the lighting intensity or the like may also be set with a qualified range depending on needs and serve as a screening standard of the detection. Detailed operation of shooting a qualified product may comprise capturing images of one position or a plurality of positions of a qualified product (e.g., the standard color content data is obtained by shooting one or more positions of a qualified product that do not comprise contamination or by shooting one or more positions that have the same features of a plurality of qualified products). Additionally, values such as the color content data, the center wavelength and the allowable range of the center wavelength or the like in the above exemplary example are all set for ease of understanding and are not equivalent to values in the practical application. Further speaking, although the RGB gray-level values of a single pixel on the image sensor are integers, the RGB gray-level values used in the operation are an average of the RGB gray-level values of multiple pixels on the image sensor, i.e., an average gray level, and thus are not necessarily integers. Although the color content data of the camera only comprise three colors of RGB in the aforesaid embodiments, gray-level value data comprising more than the three colors of RGB may be obtained by applying different cameras so as to improve the detection quality. In other words, different detection efficiencies and detection qualities can be obtained depending on characteristics of different image capture modules. For example, for a line-scanning camera of time delay integration (TDI), the RGB color filter array on the image sensor thereof is arranged in columns, and thus, during the use of the camera, images of the object can be received respectively by the R column, the G column and the B column after the scanning. Therefore, as compared with the Bayer camera, the images obtained by the TDI camera will have more abundant and more complete color information (without any interpolation operation), and better wavelength and brightness measurement accuracy can be achieved when the spectral analyzing is performed using the method of the present invention. Alternatively, when a customized filter array camera of high spectrum is used, the color filter array on the image sensor thereof may be increased depending on requirements of the user, e.g., a unit pixel array is enabled to have 16 or 25 spectrum bands therein. In this way, more accurate color information may be sensed, and better accuracy can also be achieved (gray-level value data comprising more colors is available for comparison) when the spectral analyzing is performed using the method of the present invention. Since the number of color cameras that are applicable is very large, these cameras will not be described herein one by one. Generally speaking, all the color cameras can use the method of the present invention for spectral analysis, so it does not depart from the technical principle of the present invention no matter which color camera is adopted.

According to the above descriptions, the present invention at least may have the following advantages by using the color camera for spectral analyzing:

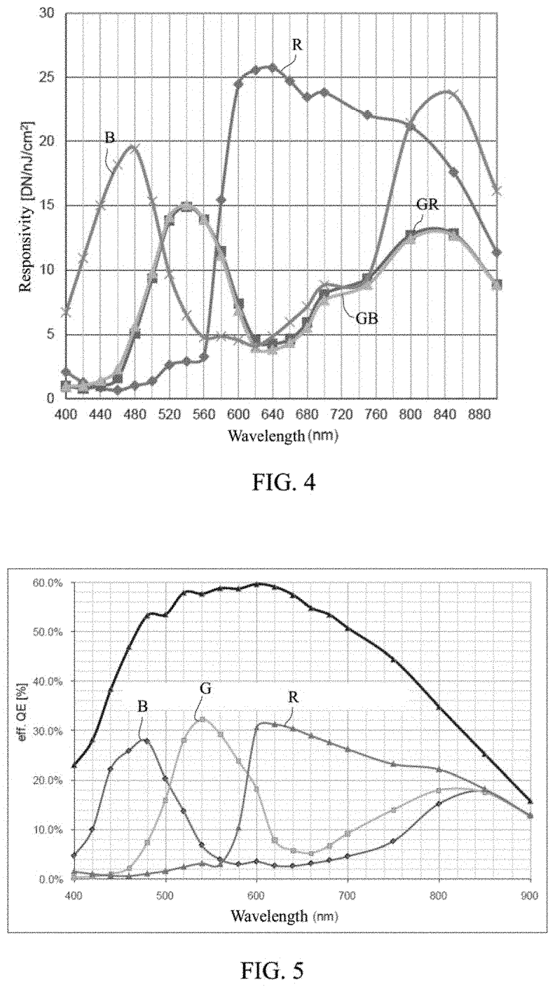

(1) Through the calibration, generation of errors in the spectral analyzing caused by the manufacturing differences between the image sensors of color cameras (differences exist among image sensors of different serial numbers even if the image sensors are of the same band and the same model) can be avoided. In other words, each camera needs to be calibrated before the spectral analyzing; otherwise, the camera is incapable of spectral analyzing even if the spectral response diagram (as shown in FIG. 4) and the QE diagram (as shown in FIG. 5) of the camera are provided by the camera manufacturer for description and sale of the product.

(2) A larger image capturing area can be achieved by using the color camera. Further speaking, information of one or more objects may be included in each triggering and shooting of the color camera operated in a surface-scanning form, and thus more information are available for analysis and detection during the back-end data processing when the same data amount is obtained as that of the traditional spectrometer (i.e., under the same computer storage capability of KB or MB values), and in this way, the analyzing and detecting operations may be more rapid and efficient. Even if the color camera is operated in the line-scanning form, more information can be comprised under the same data amount, and the exposure time of the camera can be further reduced remarkably; and thus, more products can be detected within the same time interval as compared to the traditional spectrometer, and the efficiency can be improved. Furthermore, the accuracy in the measurement of the wavelength and the brightness can be improved since no interpolation operation is included.

(3) In order to improve efficiency, as compared with the traditional spectrometer performing point-scanning or line-scanning in which images are obtained discontinuously by point-by-point or line-by-line scanning, images each time captured by the color camera are partially overlapped, so continuous information can be retrieved and a highly efficient detection speed can be maintained simultaneously, which facilitates the subsequent analyzing.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method of spectral analyzing with a color camera, comprising:
calibrating a color camera to obtain a quantum efficiency database of the color camera; shooting a detection area covering at least one object with the color camera to obtain color content data of the at least one object; and
comparing the color content data with the quantum efficiency database to analyze the at least one object.

2. The method of claim 1, wherein the step of calibrating a color camera comprises: illuminating an image sensor of the color camera with a light beam, wherein the light beam is a narrow bandwidth light beam.

3. The method of claim 1, wherein the step of shooting a detection area with the color camera comprises: providing an imaging lens set on the color camera to shoot the detection area.

4. The method of claim 1, further comprising: shooting a qualified product with the color camera to obtain a standard color content data.

5. The method of claim 4, further comprising: comparing the standard color content data with the quantum efficiency database to set a qualified range.

6. The method of claim 5, further comprising: comparing the color content data of the at least one object obtained from the color camera with the quantum efficiency database to know whether the at least one object is qualified.

7. The method of claim 5, further comprising: comparing the color content data of the at least one object obtained from the color camera with the standard color content data to know whether the at least one object is qualified.
